(19) United States
(12) Patent Application Publication
(10) Pub. No.: US 2014/0116514 A1
(43) Pub. Date: May 1, 2014

(54) VACUUM AND SHAKER FOR A HOT MELT SYSTEM

(71) Applicant: GRACO MINNESOTA INC., Minneapolis, MN (US)

(72) Inventors: Joseph E. Tix, Hastings, MN (US); Daniel P. Ross, Maplewood, MN (US); Kyle A. Bottke, Fairbault, MN (US)

(73) Assignee: GRACO MINNESOTA INC., Minneapolis, MN (US)

(21) Appl. No.: 13/705,858

(22) Filed: Dec. 5, 2012

Related U.S. Application Data
(60) Provisional application No. 61/718,224, filed on Oct. 25, 2012.

(51) Int. Cl. G05D 7/01

(52) U.S. Cl. CPC G05D 7/01
USPC 137/1; 137/98

(57) ABSTRACT

A hot melt dispensing system includes a hopper, a delivery line, a shaker, and an air supply line. The hopper stores hot melt pellets and the delivery line delivers the hot melt pellets from the hopper. The shaker agitates the hot melt pellets. The air supply line supplies air that flows through the shaker to produce vibration and additionally flows through the delivery line to create a vacuum that draws the hot melt pellets through the delivery line.

### CROSS-REFERENCE TO RELATED APPLICATION(S)

This application claims priority to U.S. Provisional Application Ser. No. 61/718,224, entitled “VACUUM AND SHAKER FOR A HOT MELT SYSTEM,” filed Oct. 25, 2012.

### BACKGROUND

The present disclosure relates generally to systems for dispensing hot melt adhesive. More particularly, the present disclosure relates to feed systems for hot melt systems.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

The system for dispensing hot melt adhesive utilizes a container such as a hopper for holding solid polymer pellets for dispensation to the material tank for melting. During low humidity and other conditions, solid polymer pellets can become bunched together and/or may cling to the sides of the hopper in a manner that is not conducive to dispensing the pellets to the remainder of the hot melt system.

### SUMMARY

According to the present invention, a hot melt dispensing system includes a hopper, a delivery line, a shaker, and an air supply line. The hopper stores hot melt pellets and the delivery line delivers the hot melt pellets from the hopper. The shaker agitates the hot melt pellets. The air supply line supplies air that flows through the shaker to produce vibration and additionally flows through the delivery line to create a vacuum that draws the hot melt pellets through the delivery line.

In another aspect of the present invention, a hot melt dispensing system includes a hopper, a delivery line, an integrated shaker and vacuum assembly, and an air supply line. The hopper stores hot melt pellets and the delivery line delivers the hot melt pellets from the hopper. The integrated shaker and vacuum assembly are connected to the delivery line. The air supply line is connected in series through the shaker to create vibration and through the vacuum assembly to apply suction to the hot melt pellets within the hopper.

According to another aspect of the present invention, a method of operating a hot melt dispensing system comprising disposing hot melt pellets in a hopper and directing air along a path that produces agitation of the hot melt pellets in the hopper and produces a vacuum to draw pellets into a delivery line.

### BRIEF DESCRIPTION OF THE DRAWINGS

FIG. 1 is a schematic view of a system for dispensing hot melt adhesive.

FIG. 2A is a perspective view of a first embodiment of a shaker and vacuum disposed on a wand.

FIG. 2B is a plan view of the shaker and vacuum of FIG. 2A.

FIG. 2C is a sectional view of the shaker and vacuum of FIG. 2A.

FIG. 3 is a perspective view of a second embodiment of the shaker and vacuum disposed on a wand.

FIG. 4 is a schematic view of a second embodiment of a system for dispensing hot melt adhesive.

FIG. 5A a perspective view of another embodiment of a shaker and vacuum mounted adjacent a hopper.

FIG. 5B is sectional view of the shaker and vacuum of FIG. 5.

FIG. 5C is a second sectional view of the shaker and vacuum of FIG. 5.

### DETAILED DESCRIPTION

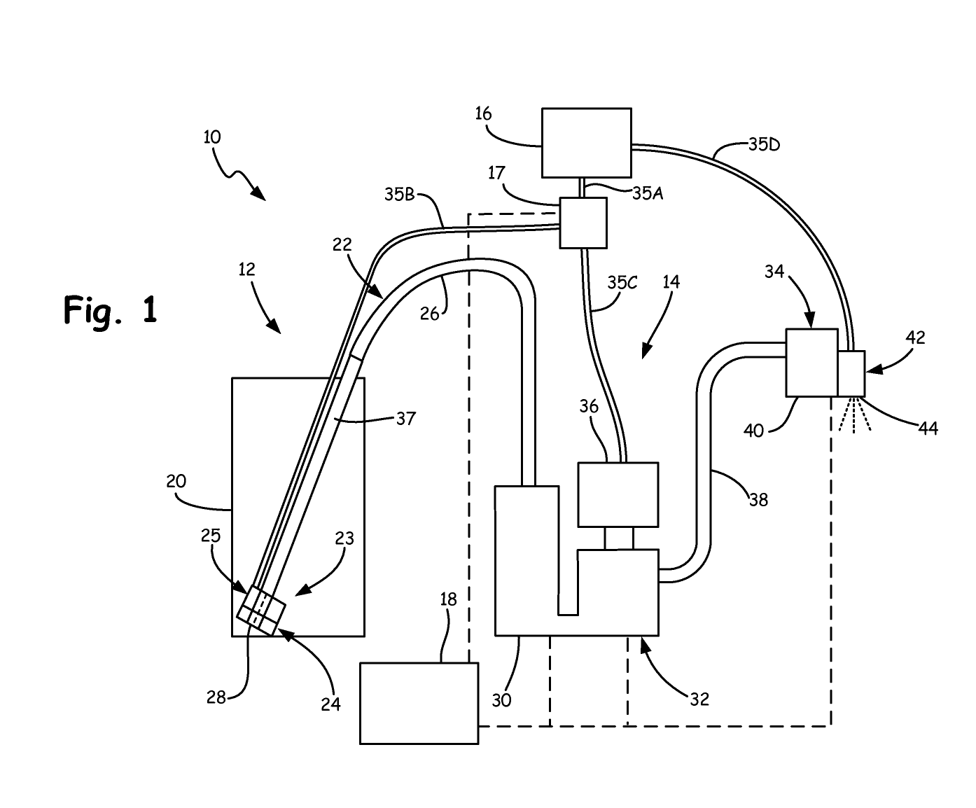

FIG. 1 is a schematic view of one embodiment of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes integrated device 23, feed hose 26, inlet 28, and wand 37. Integrated device 23 includes vacuum assembly 24 and shaker 25. In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to integrated device 23 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene.

Feed assembly 22 connects container 20 to hot section 14 for delivering the solid adhesive pellets from container 20 to hot section 14. Feed assembly 22 includes, feed hose 26, integrated device 23, and wand 37. As shown in FIG. 1, vacuum assembly 24 and shaker 25 are combined as integrated device 23, which is mounted to wand 37 adjacent to inlet 28 of wand 37. Wand 37 and integrated device 23 (shaker 25 and vacuum assembly 24) are inserted into container 20. Wand 37 extends from container 20 and connects to feed hose 26.

Compressed air from air source 16 and air control valve 17 is delivered to both shaker 25 and vacuum assembly 24. The compressed air is first used to actuate shaker 25 to agitate the adhesive pellets and in some cases to vibrate container 20. The agitation facilitates the settling of the solid adhesive pellets in container 20 as well as breaks apart bunched pellets before they reach vacuum assembly 24. After use in shaker 25, the compressed air is exhausted to operate vacuum assembly 24 to produce suction which induces the flow of the solid adhesive pellets through inlet 28, wand 37, and then through feed hose 26 to hot section 14. Wand 37 and feed hose 26 are passages sized with a diameter substantially larger than that of the solid adhesive pellets to allow the solid adhesive pellets to flow freely therethrough.

As illustrated, single air source 16 is used to supply both vacuum assembly 24 and shaker 25. The vibration/agitation induced by shaker 25 breaks apart the bunched pellets and facilitates the settling of the pellets in container 20. Settled pellets in container 20 more easily travel to vacuum assembly 24 for transport through feed assembly 22. By utilizing supply air from single air source 16 in series connection through shaker 25 and vacuum assembly 24, system 10 reduces energy consumption and system noise as well as simplifying system 10 by reducing part count including the need for additional air hoses and/or storage containers.

Solid adhesive pellets are delivered from feed hose 26 to melt system 30. Melt system 30 can include a container (not shown) and resistive heating elements (not shown) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30, through supply hose 38, to dispenser 34. Motor 36 can be an air motor driven by pulses of compressed air from air source 16 and air control valve 17. Pump 32 can be a linear displacement pump driven by motor 36. In the illustrated embodiment, dispenser 34 includes manifold 40 and dispensing module 42. Hot melt adhesive from pump 32 is received in manifold 40 and dispensed via module 42. Dispenser 34 can selectively discharge hot melt adhesive whereby the hot melt adhesive is sprayed out outlet 44 of dispensing module 42 onto an object, such as a package, a case, or another object benefiting from hot melt adhesive dispensed by system 10. Dispensing module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

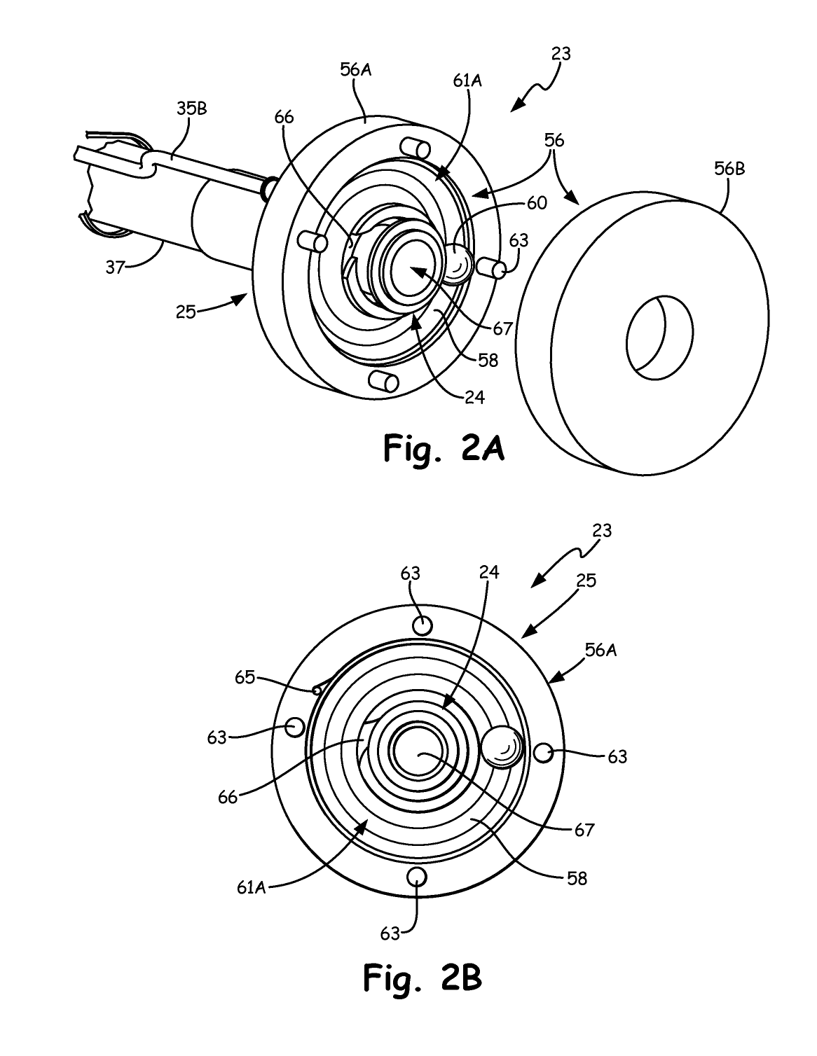

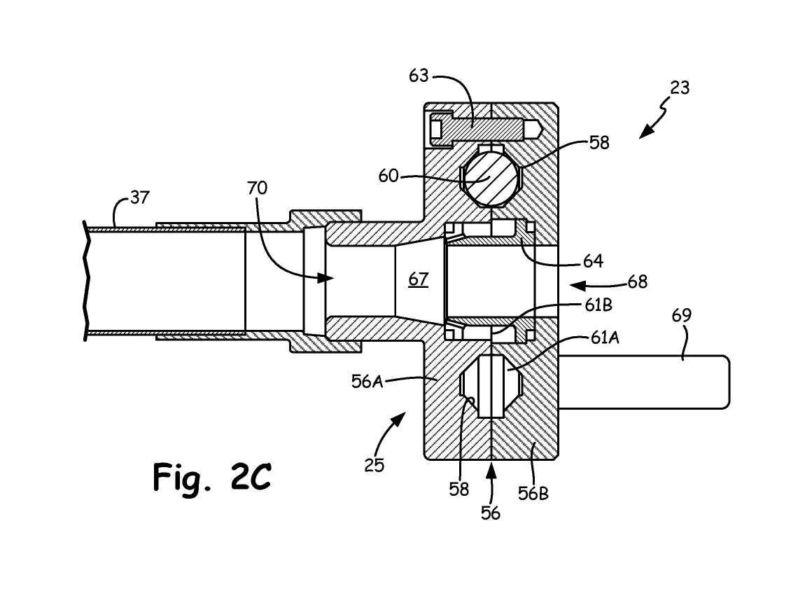

FIG. 2A shows a partially exploded perspective view of integrated device 23 and wand 37. FIG. 2A shows a plane view of integrated device 23. FIGS. 2A and 2B, which are discussed concurrently, illustrate integrated device 23, which includes shaker 25 and vacuum assembly 24 disposed together as a single unit. Shaker 25 includes housing 56 (formed by housing sections 56A and 56B), raceway 58, ball 60, fasteners 63, air inlet 65 (FIG. 2A), and air outlet 66 (FIG. 2A).

Housing 56 includes a cavity 61A bounded by raceway 58, which is adapted to receive ball 60. Sections 56A and 56B of housing 56 are held together by fasteners 63. Air inlet 65 (FIG. 2B) communicates with air hose 35B (FIG. 2A) and extends through housing 56 to communicate with the outer radius of raceway 58. Air outlet 66 (FIG. 2B) extends inward radially from raceway 58 into vacuum assembly 24.

In operation, compressed air travels from air source 16 (FIG. 1) through air inlet 65 in housing 56 into cavity 61A and travels along raceway 58. The compressed air causes ball 60 to roll along the circumference of raceway 58. The weight imbalance that results from the ball 60 rolling along raceway 58 induces vibration of shaker 25.

FIG. 2C shows a cross-section of integrated device 23 and wand 37. In addition to raceway 58, ball 60, cavity 61A, and fasteners 63, integrated device 23 includes cavity 61B, first housing portion 56A, insert 64, second housing section 56B, inlet 68, standoff 69, and outlet 70.

As shown in FIG. 2C, first and second housing sections 56A and 56B comprise portions of housing 56 for shaker 25 as well as forming a housing for vacuum assembly 24. Insert 64 is disposed between first and second housing sections 56A and 56B and forms a section of passageway through integrated device 23. Standoff 69 extends from second housing potion 67.

Air outlet 66 (FIG. 2B) extends through housing 56 to communicate with cavity 61 radially outward of insert 64. Thus, air outlet 66 (FIG. 2B) allows exhausted compressed air from shaker 25 to travel to vacuum assembly 24. Passageway 67 extends through housing 56 from inlet 68 to outlet 70. Inlet 68 is formed in second housing section 56B and is adapted to receive adhesive pellets within container 20 (FIG. 1). Passageway 67 extends from inlet 68 through second housing section 56B, insert 64 and first housing section 56A to outlet 70. Outlet 70 is formed by first housing section 56A and is adapted to connect to the end of wand 37. Standoff 69 can contact container 20 (FIG. 1) to provide for some space between inlet 68 and container 20. This space allows pellets to travel to inlet 68.

In operation, compressed air is exhausted from cavity 61A of housing 56 through air outlet 66 to cavity 61B radially outward of insert 64. As is illustrated in FIG. 2C, in one embodiment vacuum assembly 24 comprises a Venturi vacuum. The Venturi vacuum is formed by the disposition of insert 64 (with smaller cross-sectional area) relative to first portion 62 (which has a larger cross-sectional area adjacent insert 64). In particular, the Venturi vacuum is characterized by a region where the passageway 67 from inlet 68 has a constant or slightly decreasing cross-sectional area. At the circumferential outlet of cavity 61B (at the end of insert 64), the cross-sectional area of passageway 67 abruptly increases creating a diverging section within vacuum assembly 24. Diverging section is disposed downstream of outlet of cavity 61. A converging section (a region where passageway has a decreasing or constant cross-sectional area) is disposed downstream of diverging portion and extends substantially to outlet 70.

In operation, compressed air is exhausted from cavity 61A of shaker 25 and flows to cavity 61B. The compressed air then passes through diverging portion between the insert 64 and the first housing section 56A. While passing through the diverging portion and then the converging portion, the compressed air is subject to the Venturi effect. As a result of this effect, the velocity of the compressed air (and the velocity of the adhesive pellets drawn through inlet 68 by the pressure differential caused by the flow of compressed air) is increased. The increased velocity that results from the Venturi effect allows vacuum assembly 24 to discharge the adhesive pellets effectively along the length of feed hose 26 (FIG. 1). Further, in the present invention air flows in series from the shaker 25 to the vacuum assembly 24 to reduce energy consumption and system noise as well as simplifying system 10 by reducing part count including the need for additional air hoses and/or storage containers.

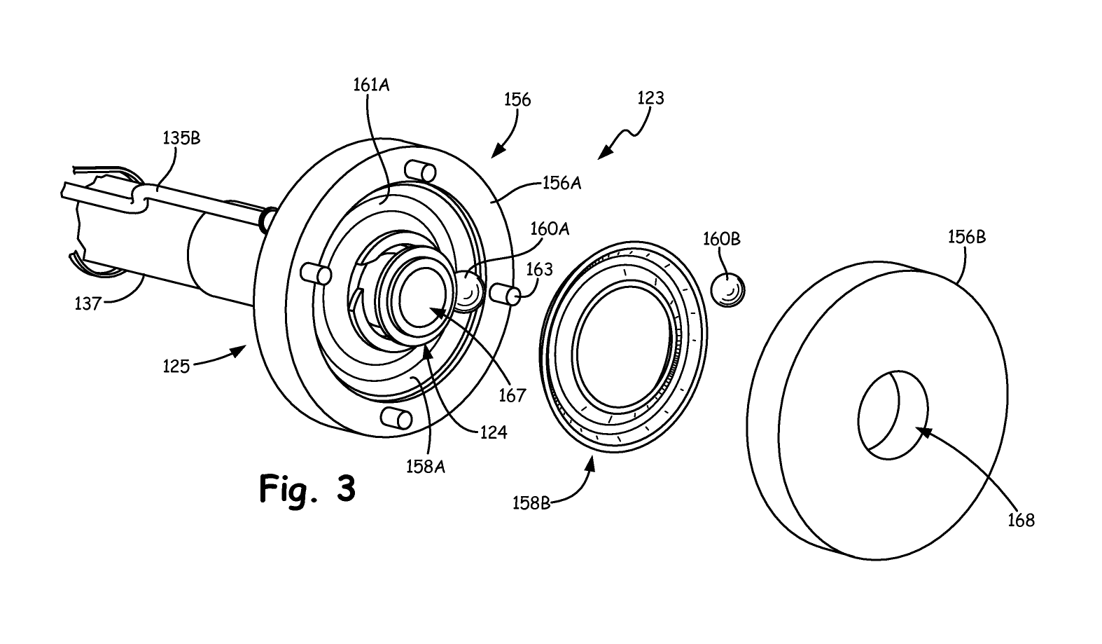

FIG. 3 shows a perspective view of another embodiment of integrated device 123 and wand 147. Integrated device 123 includes shaker 125 and vacuum assembly 124 disposed together as a single unit. Shaker 125 includes housing 156, first raceway 158A, ball 160A, fasteners 163, second raceway insert 158B, and second ball 160B.

FIG. 3 illustrates shaker 125 with section 156B of housing 156 and raceway 158 removed to illustrate the interior of shaker 125. Housing section 156A has a cavity 161A bounded by first raceway 158A, which is adapted to receive ball 160A. Sections 156A and 156B of housing 156 are held together by fasteners 163. Second raceway insert 158B is shown exploded out from raceway 158A and shaker 125. Second raceway insert 158B is sized for insertion into raceway 158A and indeed can be inserted therein as desired. Prior to insertion of second raceway insert 158B, ball 160A is removed. Second ball 160B is used in shaker 125 with second raceway insert 158B, as second raceway insert 158B is sized for use with second ball 160B.

Second raceway insert 158B and second ball 160B can be used in applications where large vibration from the shaker 125 is not desirable or not necessary. Such situations could occur, for example, in more humid environments where pellets are less apt to clump together and/or where the use of a smaller hopper is desirable.

In operation with second raceway insert 158B and second ball 160B inserted, compressed air travels from a single air source through an air inlet (not shown) in housing 156 into inner cavity 161A as defined by second raceway insert 158B. The compressed air causes second ball 160A to roll along the circumference of second raceway 158A. The weight imbalance that results from the second ball 160A rolling along second raceway 158A induces vibration of shaker 125.

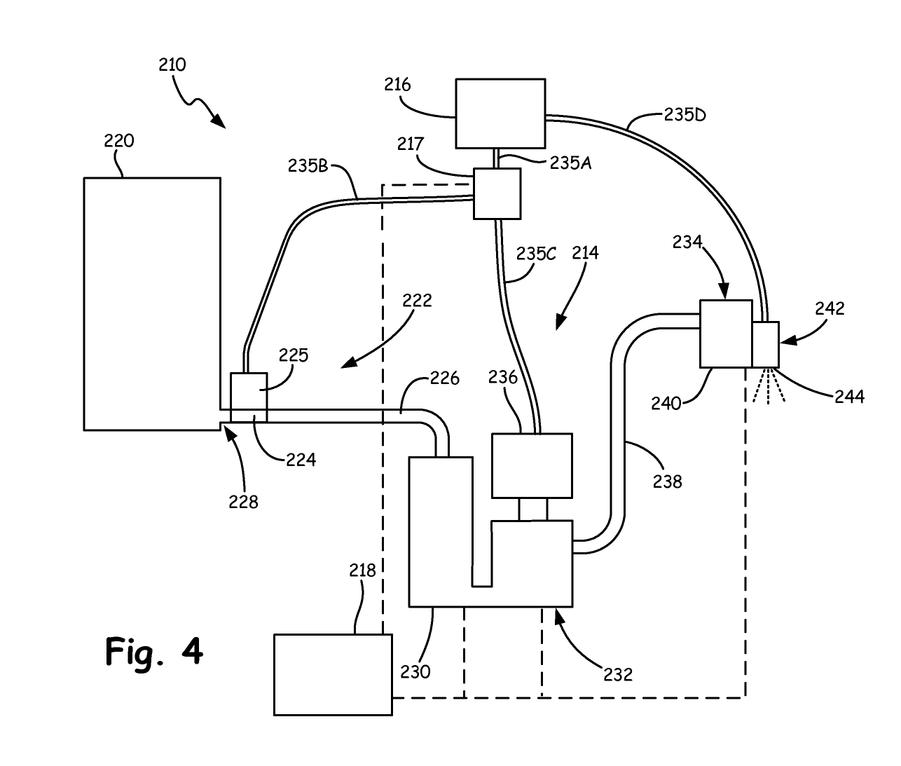

FIG. 4 is a schematic view of system 210, which is a system for dispensing hot melt adhesive. System 210 includes cold section 212, hot section 214, air source 216, air control valve 217, and controller 218. In the embodiment shown in FIG. 4, cold section 212 includes container 220 and feed assembly 222, which includes vacuum assembly 224, shaker 225, feed hose 226, and inlet 228. In the embodiment shown in FIG. 4, hot section 214 includes melt system 230, pump 232, and dispenser 234. Air source 216 is a source of compressed air supplied to components of system 210 in both cold section 212 and hot section 214. Air control valve 217 is connected to air source 216 via air hose 235A, and selectively controls air flow from air source 216 through air hose 235B to vacuum assembly 224 and shaker 225 and through air hose 235C to motor 236 of pump 232. Air hose 235D connects air source 216 to dispenser 234, bypassing air control valve 217. Controller 218 is connected in communication with various components of system 210, such as air control valve 217, melt system 230, pump 232, and/or dispenser 234, for controlling operation of system 210.

Components of cold section 212 can be operated at room temperature, without being heated. Container 220 can be a hopper for containing a quantity of solid adhesive pellets for use by system 210. Suitable adhesives can include, for example, a thermoplastic polymer glue such as ethylene vinyl acetate (EVA) or metallocene.

Feed assembly 222 connects container 220 to hot section 214 for delivering the solid adhesive pellets from container 220 to hot section 214. Feed assembly 222 includes vacuum assembly 224, shaker 225, and feed hose 226. As shown in FIG. 4, vacuum assembly 224 is positioned adjacent to and communicates with container 220. Shaker 225 is mounted to or adjacent to container 220 and vacuum assembly 224.

Compressed air from air source 216 and air control valve 217 is delivered to both shaker 225 and vacuum assembly 224. The compressed air is first used to actuate shaker 225 to agitate the solid adhesive pellets and in some cases vibrate container 220. As illustrated in the embodiment shown in FIG. 4, the vibration agitates the pellets and facilitates the settling of the adhesive pellets in the container 220 as well as breaks apart bunched pellets before they reach vacuum assembly 224. After use in the shaker 225, the compressed air is exhausted to operate vacuum assembly 224 to create a vacuum, which induces flow of solid adhesive pellets through inlet 228 of vacuum assembly 224 and then through feed hose 226 to hot section 214.

Feed hose 226 connects vacuum assembly 224 to hot melt section 214. Feed hose 226 is a tube or other passage sized with a diameter substantially larger than that of the solid adhesive pellets to allow the solid adhesive pellets to flow freely through feed hose 226.

As illustrated, the same single air source 216 is used to supply both vacuum assembly 224 and shaker 225. The vibration induced by shaker 225 agitates and breaks apart the bunched pellets and facilitates the settling of the pellets in container 220. The settled non-clumped pellets are more easily drawn to vacuum assembly 224 for transport through feed assembly 222. By utilizing supply air from the same air source 216 in series to operate both shaker 225 and then vacuum assembly 224, system 210 reduces energy consumption and system noise as well as simplifying system 210 by reducing part count including the need for additional air hoses and/or air sources.

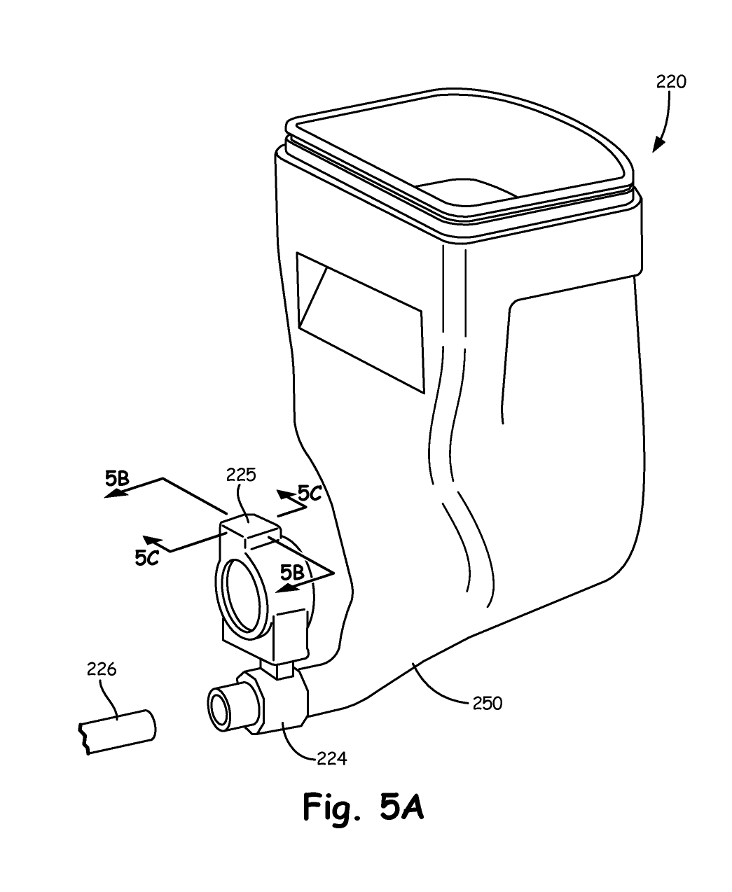

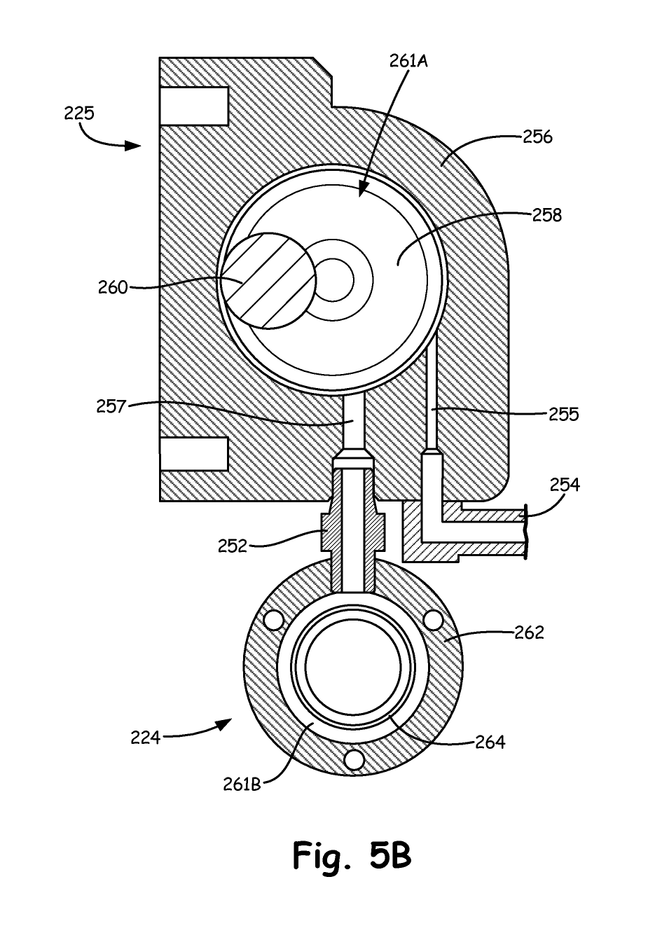

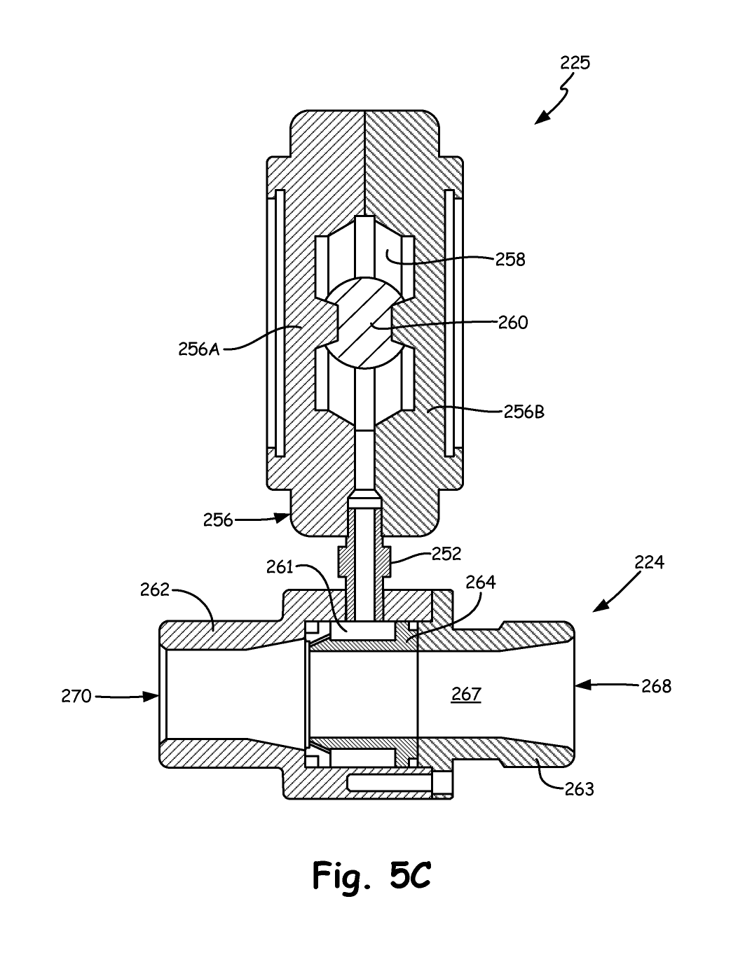

FIG. 5A shows an embodiment of shaker 225 and vacuum assembly 224 mounted to a feed portion 250 of container 220. As shown in FIG. 5A, shaker 225 and vacuum assembly 224 are illustrated without features such as air hose 235B (FIG. 4) and with feed hose 226 disconnected and only partially shown. Shaker 225 and vacuum assembly 224 comprise separate units with the shaker 225 mounted to the vacuum assembly 224. As discussed previously, compressed exhaust air from shaker 225 is used to operate vacuum assembly 224.

Vacuum assembly 224 is connected to feed portion 250 of container 220. This disposes shaker 225 in close proximity to container 220 such that vibrations generated by shaker 225 agitate the solid adhesive pellets, container 220, as well as vacuum assembly 224. The vibration induced by shaker 225 breaks apart bunched pellets and facilitates the settling of the pellets to feed portion 250 of container 220.

FIG. 5B shows a first cross-section of vacuum assembly 224 and shaker 225. FIG. 5C shows a second cross-section of vacuum assembly 224 and shaker 225 along a perpendicular plane to the cross-section of FIG. 5A. As shown in FIGS. 5B and 5C, shaker 225 is connected to vacuum assembly 224 by fitting 252. Shaker 225 includes air inlet 254 (FIG. 5B), housing 256, raceway 258, and ball 260. Vacuum assembly 224 includes first portion 262, second portion 263, and passageway 267 with insert 264, inlet 266 (FIG. 5B), and outlet 268 (FIG. 5B).

Air inlet 254 extends from housing 256 and communicates with air hose 235B (FIG. 4). Air inlet 254 communicates with inner cavity 261A of housing 256 via an inlet passageway 255 (FIG. 5A) through the housing 256. Inner cavity 261A is bounded by raceway 258 and contains ball 260. Inner cavity also communicates with an outlet passageway 257 (FIG. 5A), which extends through housing 256 to fitting 252.

In the embodiment shown, fitting 252 comprises a hollow nipple that extends between shaker 225 and vacuum assembly 224 and extends through first portion 262 to communicate with a cavity 261 (FIG. 5B) radially outward of insert 264. Fitting 252 connects shaker 225 to vacuum assembly 224 and allows exhausted compressed air from shaker 225 to travel to vacuum assembly 224. Inlet 268 (FIG. 5B) is adapted to connect to feed portion 250 of container 220 to receive adhesive pellets. Passageway 267 extends from inlet 268 through second portion 263, insert 264 and first portion 262 to outlet 270. Outlet 270 (FIG. 5B) is formed by first portion 262 and is adapted to connect to feed hose 226 (FIG. 4) of feed assembly 222 (FIG. 4).

In FIGS. 5B and 5C, shaker 225 is mounted to vacuum assembly 224, however in other embodiments shaker 225 can be mounted at a distance from vacuum assembly 224. For example, shaker 225 can be mounted directly to or within container 220 and exhaust air used to operate shaker 225 can pass through a length of hose or similar air line to be used to operate vacuum assembly 224.

In operation, compressed air travels from air source 216 (FIG. 4) through air inlet 254 and inlet passageway 255 in housing 256 to inner cavity 261A. The compressed air causes ball 260 to roll along the circumference of raceway 258. The weight imbalance that results from the ball 260 rolling along raceway 258 induces vibration of shaker 225.

The compressed air is exhausted from inner cavity 261A through outlet passageway 257 in housing 256. The air passes through fitting 252 and through first portion 262 to the cavity 261B radially outward of insert 264. Similar to the embodiment of FIG. 2C, in one embodiment vacuum assembly 224 comprises a Venturi vacuum and operates in the manner previously discussed in order to create suction and discharge the adhesive pellets effectively along the length of feed hose 226 (FIG. 4).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A hot melt dispensing system comprising:
a hopper for storing hot melt pellets;
a delivery line for delivering hot melt pellets from the hopper;
a shaker for agitating the hot melt pellets; and
an air supply line connected to supply air that flows through the shaker to produce vibration, wherein the supply air additionally flows through the delivery line to create a vacuum that draws the hot melt pellets through the delivery line.

2. The hot melt dispensing system of claim 1, wherein the vacuum comprises:
a Venturi for creating a low pressure zone in the delivery line for inducing flow of hot melt pellets from the hopper into the delivery line.

3. The hot melt dispensing system of claim 2, wherein the shaker and vacuum comprise an integrated device.

4. The hot melt dispensing system of claim 1, wherein the delivery line includes a wand that is inserted into the hopper, and wherein the shaker is mounted to and the vacuum is created at an end portion of the wand.

5. The hot melt dispensing system of claim 1, wherein the shaker includes a Venturi.

6. The hot melt dispensing system of claim 1, wherein the delivery line comprises a feed tube and wherein the shaker and vacuum are disposed between the hopper and the feed tube.

7. The hot melt dispensing system of claim 1, wherein the shaker and vacuum are arranged in series along the air supply line.

8. The hot melt dispensing system of claim 1, wherein the shaker includes a first raceway adapted to receive one or more balls of a first size.

9. The hot melt dispensing system of claim 8, further comprising a second raceway adapted to receive one or more balls of a second size, wherein the second raceway is sized for insertion into the first raceway.

10. The hot melt dispensing system of claim 1, wherein the vacuum operates on exhaust air from the shaker.

11. A hot melt dispensing system comprising:
a hopper for storing hot melt pellets;
a delivery line for delivering hot melt pellets from the hopper; and
an integrated shaker and vacuum assembly connected to the delivery line; and
an air supply line that travels in series through the shaker to create vibration and through the vacuum assembly to apply suction to the hot melt pellets within the hopper.

12. The hot melt dispensing system of claim 11, wherein the vacuum assembly comprises:
a Venturi for creating a low or high pressure zone in the delivery line for inducing flow of hot melt pellets from the hopper into the delivery line.

13. The hot melt dispensing system of claim 11, wherein the delivery line includes a wand that is inserted into the hopper, and wherein the integrated shaker and vacuum assembly is mounted to an end portion of the wand.

14. The hot melt dispensing system of claim 11, wherein the delivery line comprises a feed tube and wherein the shaker and vacuum assembly are disposed between the hopper and the feed tube.

15. The hot melt dispensing system of claim 11, wherein the integrated shaker and vacuum includes a raceway adapted to receive one or more balls.

16. The hot melt dispensing system of claim 11, wherein the vacuum assembly operates on exhaust air from the shaker.

17. A method of operating a hot melt dispensing system, the method comprising:
disposing hot melt pellets in a hopper; and
directing air along a path that produces agitation of the hot melt pellets in the hopper and produces a vacuum to draw pellets into a delivery line.

18. The method of claim 17, further comprising delivering the hot melt pellets through the delivery line to a melter.

19. The method of claim 18, wherein the vacuum comprises:
a Venturi for creating a low pressure zone in delivery line for inducing flow of hot melt pellets from the hopper into the delivery line.

20. The method of claim 19, wherein the path the air travels is through a shaker and a Venturi vacuum.
